(19) United States
(12) Patent Application Publication
(10) Pub. No.: US 2005/0268968 A1
(43) Pub. Date: Dec. 8, 2005

(54) Pressure control system for low pressure high flow operation

(76) Inventor: Gabriel Hourtouat, Bolton (CA)

Correspondence Address: BERESKIN AND PARR, 40 KING STREET WEST, BOX 401, TORONTO, ON, M5H 3Y2, CA

(21) Appl. No.: 11/142,668

(22) Filed: Jun. 2, 2005

Related U.S. Application Data
(63) Continuation-in-part of application No. 10/716,553, filed on Nov. 20, 2003, now Pat. No. 6,935,363.

(51) Int. Cl. G05D 16/18

(52) U.S. Cl. 137/492

(57) ABSTRACT

A pressure control system for controlling the pressure of a process fluid stream at a certain location, comprising: a pressure regulator disposed in the process fluid stream, through which the process fluid stream flows; a first pilot controller adapted to sense the pressure of the process fluid at the said location and receive a control pressure from a control source; a second pilot controller adapted to receive same control pressure from the control source and provide added pressure; an inspirator adapted to receive the added pressure from the second pilot controller and generate a differential pressure; wherein the differential pressure is used to control the pressure of the process fluid stream within the pressure regulator. The pressure regulator comprises a first chamber and a second chamber therein separated by a flexible element and a divider is disposed in the first chamber and operative to abut against the flexible element to divide the first chamber into separate spaces. Preferably, the pressure regulator is disposed such that the flexible element extends substantially in vertical direction and the divider extends substantially in horizontal direction. The pressure control system further comprises an automatic control system including an electronic proportional-integral-derivative controller adapted to control the process fluid pressure based on pressure measurements received from a pressure transducer.

### FIELD OF THE INVENTION

The present invention relates generally to a pressure control system. More particularly, the present invention relates to a pressure control system for low pressure operation at increased flow rates.

### BACKGROUND OF THE INVENTION

It is often desirable to accurately control the pressure of a process fluid stream at a certain point in an industrial system. The process fluid can be gas, liquid, or mixture thereof. For example, in a fuel cell system or a fuel cell testing system, it is necessary to operate the fuel cell under controlled pressure conditions. A common technique is to control the pressure of a process fluid stream adjacent the inlet or outlet of the fuel cell for that process fluid stream. To this end, a pressure regulator is often utilized to control the pressure at this point.

A known pressure control system comprises an unloading type flexible element pressure regulator and a piloting system. The pressure regulator is disposed in the process fluid stream line and in operation, allows the process fluid to flow through a chamber thereof disposed on one side of the flexible element, e.g. a diaphragm. A pilot controller senses the pressure at the point where the pressure of the process fluid stream is to be accurately controlled, and correspondingly controls the pressure of another chamber on the other side of the flexible element of the pressure regulator, thereby eventually balancing the pressure on both sides of the flexible element. By manually adjusting the preset pressure of the pilot controller, the pressure of the process fluid stream at the desired point can be controlled. Such pressure regulator and the piloting system and the way they are operated are commercially available from, for example, Mooney Controls.

However, it has been found that this type of pressure control system cannot meet the increasingly strict requirement in terms of accuracy and stability, when a system operates at low pressure, e.g. less than 7 psig, partly because the pressure regulator needs a certain pressure drop across it to activate the pressure balancing mechanism and such pressure drop is often not available when pressure of the process fluid stream is extremely low.

Therefore, there remains a need for a pressure control system that accurately controls the pressure of a process fluid stream at a certain point, under a range of pressure conditions including very low pressure of the process fluid stream, and at increased flow rates.

### SUMMARY OF THE INVENTION

Taught in accordance with a broad aspect of the invention is a pressure control system for controlling the pressure of a process fluid stream at a certain location in response to a pressure disturbance caused by process equipment located in the process fluid stream. The pressure control system comprises:
a. a pressure regulator having an inlet and an outlet for the process fluid and including an actuating element actuated by pressure of an actuating fluid to control opening of the pressure regulator and thereby to control flow of the process fluid between the inlet and outlet thereof;
b. a fluid control means having an inlet and an outlet and a control line intermediate the inlet and the outlet, wherein the inlet is connected to a supply of actuating fluid, the control line is connected to the pressure regulator to control supply of the actuating fluid to the pressure regulator and thereby controls the pressure regulator, and the actuating fluid exits through the outlet;
c. a first pilot valve, including a sense port for receiving a sensed fluid pressure from a first location in the process fluid stream, a first target port for inputting a target pressure, an inlet port for receiving actuating fluid connected to the outlet of the fluid control means, an outlet port, and a first valve actuable in response to the sensed fluid pressure to control flow of the actuating fluid from the fluid control means and thereby to control flow of the actuating fluid to the pressure regulator;
d. a pressure measurement means for measuring fluid pressure at a second location in the process fluid stream and outputting a signal corresponding with the pressure measurement; and
e. a control unit for receiving the signal from the pressure measurement means, comparing the signal with a set-point, and communicating the target pressure to the first target port.

Taught in accordance with another broad aspect of the invention is a pressure control system for controlling the pressure of a process fluid stream at a certain location in response to a pressure disturbance caused by process equipment located in the process fluid stream. The pressure control system comprises:
a. a pressure regulator having an inlet and an outlet for the process fluid and including an actuating element actuated by pressure of an actuating fluid to control opening of the pressure regulator and thereby to control flow of the process fluid between the inlet and outlet thereof;
b. a fluid control means having an inlet and an outlet and a control line intermediate the inlet and the outlet, wherein the inlet is connected to a supply of actuating fluid, the control line is connected to the pressure regulator to control supply of the actuating fluid to the pressure regulator and thereby controls the pressure regulator, and the actuating fluid exits through the outlet; and
c. a first pilot valve, including a sense port for receiving a sensed fluid pressure from a first location in the process fluid stream, a first target port for inputting a target pressure, an inlet port for receiving actuating fluid connected to the outlet of the fluid control means, an outlet port, and a first valve actuable in response to the sensed fluid pressure to control flow of the actuating fluid from the fluid control means and thereby to control flow of the actuating fluid to the pressure regulator.

Taught in accordance with another broad aspect of the invention is a pressure control system for controlling the pressure of a process fluid stream at a certain location in response to a pressure disturbance caused by process equipment located in the process fluid stream. The pressure control system comprises:
a. a pressure regulator having an inlet and an outlet for the process fluid and including an actuating element actuated by pressure of an actuating fluid to control opening of the pressure regulator and thereby to control flow of the process fluid between the inlet and outlet thereof;
b. a fluid control means having an inlet and an outlet and a control line intermediate the inlet and the outlet, wherein the inlet is connected to a supply of actuating fluid, the control line is connected to the pressure regulator to control supply of the actuating fluid to the pressure regulator and thereby controls the pressure regulator, and the actuating fluid exits through the outlet;
c. a first pilot valve, including a sense port for receiving a sensed fluid pressure from a first location in the process fluid stream, a first target port for inputting a target pressure, an inlet port for receiving actuating fluid, an outlet port connected to the inlet of the fluid control means, and a first valve actuable in response to the sensed fluid pressure to control flow of the actuating fluid to the fluid control means and thereby to control flow of the actuating fluid to the pressure regulator;
d. means for restricting the flow of actuator fluid having an inlet connected to the outlet of the fluid control means, and an outlet;
e. a pressure measurement means for measuring fluid pressure at a second location in the process fluid stream and outputting a signal corresponding with the pressure measurement; and
f. a control unit for receiving the signal from the pressure measurement means, comparing the signal with a set-point, and communicating the target pressure to the first target port.

Taught in accordance with another broad aspect of the invention is a pressure control system for controlling the pressure of a process fluid stream at a certain location in response to a pressure disturbance caused by process equipment located in the process fluid stream. The pressure control system comprises:
a. a pressure regulator having an inlet and an outlet for the process fluid and including an actuating element actuated by pressure of an actuating fluid to control opening of the pressure regulator and thereby to control flow of the process fluid between the inlet and outlet thereof;
b. a fluid control means having an inlet and an outlet and a control line intermediate the inlet and the outlet, wherein the inlet is connected to a supply of actuating fluid, the control line is connected to the pressure regulator to control supply of the actuating fluid to the pressure regulator and thereby controls the pressure regulator, and the actuating fluid exits through the outlet;
c. a first pilot valve, including a sense port for receiving a sensed fluid pressure from a first location in the process fluid stream, a first target port for inputting a target pressure, an inlet port for receiving actuating fluid, an outlet port connected to the inlet of the fluid control means, and a first valve actuable in response to the sensed fluid pressure to control flow of the actuating fluid to the fluid control means and thereby to control flow of the actuating fluid to the pressure regulator;
d. means for restricting the flow of actuator fluid having an inlet connected to the outlet of the fluid control means, and an outlet.

### BRIEF DESCRIPTION OF THE DRAWINGS

For a better understanding of the present invention, and to show more clearly how it may be carried into effect, reference will now be made, by way of example, to the accompanying drawings, which show a preferred embodiment of the present invention and in which:

FIG. 1 is a schematic view of a known pressure control system;

FIG. 2 is a schematic view of an embodiment of a pressure control system according to the present invention;

FIG. 3 is an enlarged portion of the schematic view of FIG. 2 showing a regulator in greater detail;

FIG. 4 is an enlarged portion of the schematic view of FIG. 2 showing a inspirator in greater detail;

FIG. 5 is an enlarged portion of the schematic view of FIG. 2 showing a primary pilot in greater detail;

FIG. 6 is an enlarged portion of the schematic view of FIG. 2 showing a secondary pilot in greater detail;

FIG. 7 shows an end view of a portion of the regulator of FIG. 2;

FIG. 8 shows test results of pressure at a fuel cell stack inlet with various process fluid flows using the pressure control system of FIG. 2;

FIG. 9 is a schematic view of an embodiment of a pressure control system according to the present invention;

FIG. 10 is a schematic view of an embodiment of a pressure control system according to the present invention;

FIG. 11 is a schematic view of an embodiment of a pressure control system according to the present invention; and

FIG. 12 is a schematic view of an embodiment of a pressure control system according to the present invention.

### DETAILED DESCRIPTION OF EMBODIMENTS OF THE INVENTION

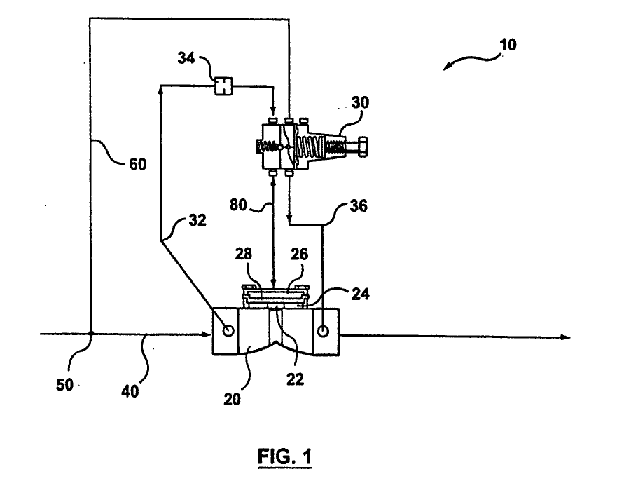

A known pressure control system is shown generally at 10 in FIG. 1. The pressure control system 10 comprises an unloading type flexible element pressure regulator 20 and a piloting system. The pressure regulator 20 is disposed in the process fluid stream line 40 and in operation, allows the process fluid to flow through a chamber 24 thereof disposed on one side of the flexible element, e.g. a diaphragm 28. A divider 22 is disposed in the chamber 24 to adjust the pressure therein. The divider 22 initially abuts against the flexible element 28 and hence prevents the process fluid from flowing through the chamber 24. As the process fluid is continuously fed into the chamber 24, pressure in the chamber 24 increases and the diaphragm 28 is lifted. This permits the flow of the process fluid through the chamber 24. A pilot controller 30 senses, via a sense line 60, the pressure at the point 50 where the pressure of the process fluid stream is to be accurately controlled, and correspondingly controls, via a control line 80, the pressure of another chamber 26 on the other side of the flexible element 28 of the pressure regulator 20, thereby eventually balancing the pressure on both sides of the flexible element 28, at a desired pressure. A further line 32, including an orifice or throttle 34 is connected to the pilot controller 30, and an exhaust line 36 is also provided. By manually adjusting the preset pressure of the pilot controller 30, the pressure of the process fluid stream at the desired point 50 can be controlled. As mentioned above, this system needs a pressure differential across the pressure regulator 20 to activate. It is inadequate to achieve accurate pressure control in low pressure conditions.

In use, fluid is supplied through the line 32 and orifice 34 to the pilot controller 30. When too low a pressure is sensed by the controller 30, it is maintained in a closed position, so that flow from the line 32 is directed to the line 80 to maintain the pressure regulator 20 closed, thereby to increase the pressure in the line 40. When sufficient pressure is present at port 50, this pressure is applied through the sense line 60 to the pilot controller 30 to open the controller against the action of the spring indicated therein. This permits at least part of the flow from line 32 to be exhausted through the exhaust line 36 to the outlet of the pressure regulator 20. Consequently, the pressure on the diaphragm 28 is reduced, permitting the regulator 20 to open, permitting increased flow through the line 40.

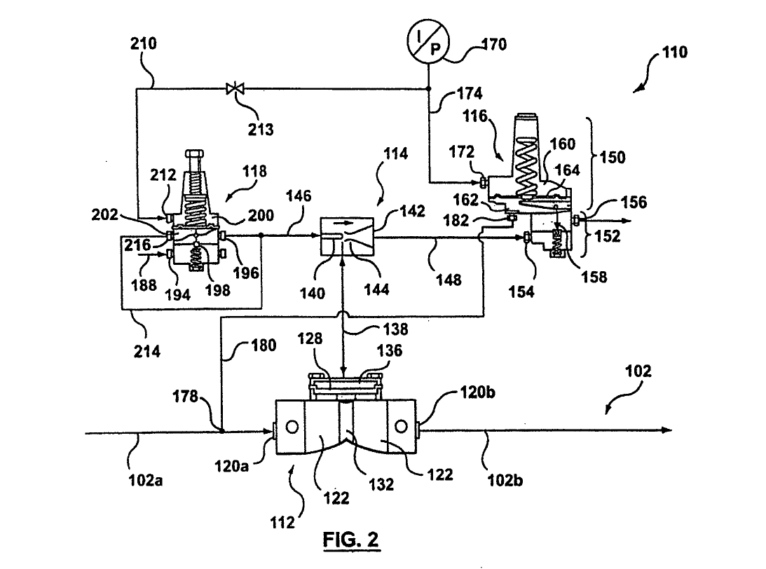

A pressure control system according to the present invention is shown generally at 110 in FIG. 2. The pressure control system 110 has a pressure regulator 112, an inspirator 114, a primary (lower pressure) pilot valve 116, and a secondary (higher pressure) pilot valve 118.

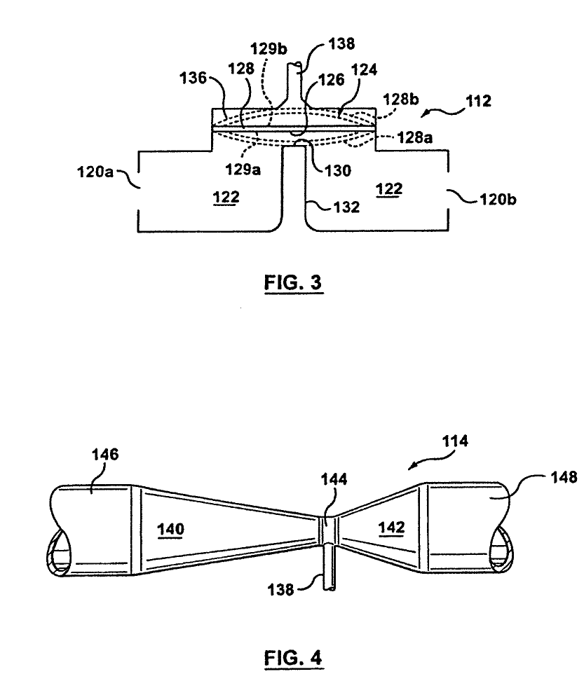

The pressure regulator 112 is mounted in a process fluid line 102 to adjustably control the rate of flow of a fluid through the line 102. More particularly, the regulator 112 has an inlet port 120a in fluid communication with an upstream line 102a of the process fluid line 102, and an outlet port 120b in fluid communication with a downstream line 102b of the process fluid line 102. As best seen in FIG. 3, the regulator 112 is further provided with a flow channel 122 extending between the inlet and outlet ports 120a, 120b and with a closure means 124 in the flow channel 122. The closure means 124 is variably adjustable between a fully closed position, in which the ports 102a and 102b are fluidly isolated from each other, and a fully open position in which a maximum rate of flow is permitted through the flow channel 122.

In the embodiment illustrated, the closure means 124 comprises a sealing surface 126 attached to a flexible actuating diaphragm 128. The diaphragm 128 serves as an actuator for advancing the sealing surface 126 towards, or retracting the sealing surface 126 away from, an engagement surface 130 provided on a divider element 132. The divider element 132 can be in the form of a fixed wall extending into the flow channel 122. When the sealing surface 126 abuts the engagement surface 130, the closure means 124 is in the fully closed position and flow through the channel 122 is denied.

The actuating diaphragm 128 can move in response to a pressure differential across the thickness of the diaphragm 128. Accordingly, in the embodiment illustrated, one face 129a of the diaphragm 128 (i.e. the face with the sealing surface 126) partially defines the flow channel 122, and the opposite face 129b of the diaphragm 128 partially defines a control chamber 136. By controlling pressure in the control chamber 136 relative to that of the flow channel 122, the position of the actuating diaphragm 128, and hence of the closure means 124, can be controlled, and moved between a fully lowered position 128a and a fully raised position 128b (shown in phantom in FIG. 3), corresponding to fully closed and fully open positions of the valve closure means 124. In steady state operation, the pressures in the flow channel 122 and control chamber 136 are equal, and the diaphragm 128 is substantially stationary.

According to the present invention, the pressure in the control chamber 136 is adjusted by forcing actuator fluid into, or evacuating actuator fluid from, the chamber 136 via a pressure control line 138 that extends between the chamber 136 and the inspirator 114 (FIG. 2). More particularly, the inspirator 114 has, in the form of a venturi, a converging inlet 140, a diverging outlet 142, and a throat 144 between the inlet 140 and outlet 142. The pressure control line 138 extends between the control chamber 136 and the throat 144 of the inspirator 114 (FIG. 4).

The inspirator 114 receives a flow of actuator fluid at its inlet 140 via an inspirator supply line 146, and discharges a flow of actuator fluid from its outlet 142 via an inspirator vent line 148. According to one embodiment of the present invention, the fluid in the supply line 146 is supplied at a relatively constant, higher than target, pressure from a fluid source independent of the process fluid in line 102. The flow of fluid through the inspirator 114 is accelerated in the inspirator, so that a pressure drop is generated at the throat 144 of the inspirator. At a high rate of fluid flow across the inspirator 114 (e.g. unrestricted venting), the pressure drop can generate suction in the control chamber 136 to lift the diaphragm 128 and open the closure means 124. On the other hand, if the venting is restricted, fluid entering the inlet 140 can be directed into the chamber 136, thereby urging the diaphragm 128 downwards and closing the closure means 124.

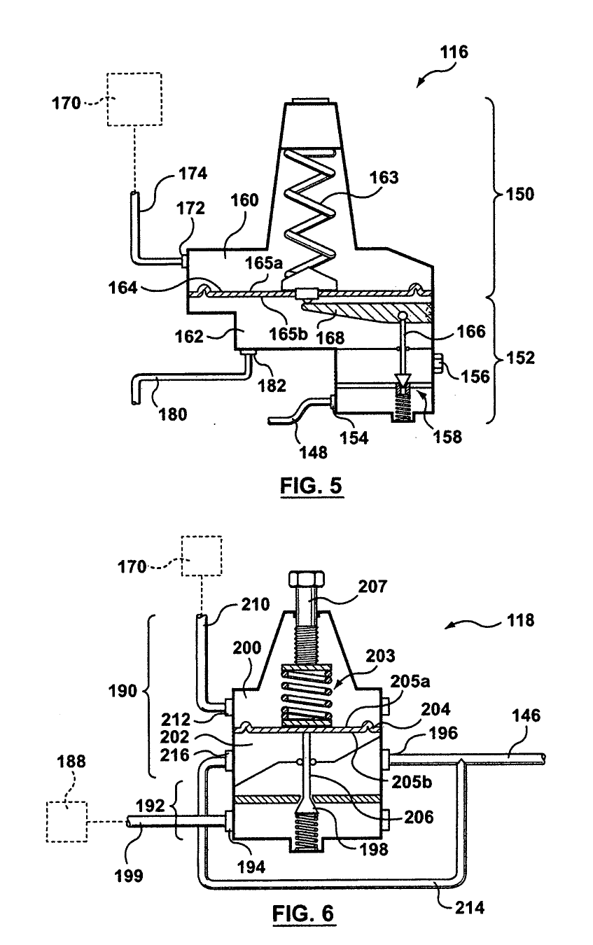

With respect to the outlet 142 of the inspirator 114, the outlet 142 is connected to the inspirator vent line 148 to provide fluid communication with the primary (low pressure) pilot valve 116 for controlled venting of the outlet 142. More particularly, and as best seen in FIG. 5, the primary pilot 116 has a control portion 150 and a valve portion 152, which are in fluid isolation from each other. The valve portion 152 has an inlet port 154, an outlet port 156, and a valve member 158 between the inlet port 154 and outlet port 156. The inspirator vent line 148 connects the outlet 142 of the inspirator 114 to the inlet port 154 of the primary pilot 116. The outlet port 156 is open to atmosphere.

The valve member 158 can move among a fully closed position, a fully open position, and a continuous range of partially open positions. In this way, the valve member 158 controls the flow of fluid from the inlet port 154 to the outlet port 156, and hence, the valve portion 152 of the primary pilot 116 controls the flow of fluid from the outlet 142 of the inspirator 114 to atmosphere.

The control portion 150 of the primary pilot 116 adjusts the position of the valve member 158 of the primary pilot 116. The control portion 150 has a target pressure chamber 160 and a sensed pressure chamber 162 that are separated from each other by a primary pilot diaphragm 164. The primary pilot diaphragm 164 has a target pressure face 165a exposed to the target pressure chamber 160, and a sensed pressure face 165b exposed to the sensed pressure chamber 162. A pressure adjustment spring 163 is housed within the target pressure chamber 160 and exerts a force against the target pressure face 165a of the diaphragm 164, as does any fluid pressure in the target pressure chamber 160. By changing the relative pressures in the target and sensed pressure chambers 160, 162, the diaphragm 164 is moved towards one of the chamber 160, 162 dependent on the pressure differential and the load set on the spring 163, which can be adjustable. The valve member 158 is connected to the diaphragm 164 by, for example, a shaft 166 and a lever 168 pivotally mounted as shown, so that movement of the diaphragm 164 adjusts the position of the valve member 158. More particularly, a downward movement of the diaphragm 164 (movement towards the sensed pressure chamber 162) closes the valve member 158, and upward movement of the diaphragm 164 (towards the target pressure chamber 160) opens the valve member 158. In the embodiment illustrated, the spring 163 is relatively soft and the surface area of the faces 165a and 165b of the diaphragm 164 are relatively large so that the diaphragm 164 has greater sensitivity to small pressure differentials across the diaphragm 164. Further, the arrangement of the shaft 166 and the lever 168 is such as to amplify a force generated by movement of the diaphragm 164 while correspondingly reducing the range of motion of the valve member 158.

The target pressure chamber 160 of the primary pilot valve 116 is in fluid communication with a target (or control) pressure input 170. More particularly, the control input 170 (FIG. 2) can be a pressurized supply of fluid regulated by, for example, but not limited to, an electronic pressure regulator, and connected to a target port 172 of the target pressure chamber 160 via a control line 174.

The sensed pressure chamber 162 of the primary pilot valve 116 is in fluid communication with a point 178 in the process fluid line 102 where the process pressure is to be controlled. In the embodiment illustrated, the point 178 where the system pressure is to be controlled is located in the upstream line 102a of the process fluid line 102. In other embodiments, the point 178 can be located in other positions of the system, such as, for example, but not limited to, the downstream line 102b of the process fluid line 102. A sense line 180 extends from a sense port 182 of the sensed pressure chamber 162 to an orifice in the line 102 at the point 178. In this way, the pressure of the fluid stream in the line 102 at the point 178 is reflected by the pressure in the sensed pressure chamber 162.

In operation, a change in process flow through the line 102 and the regulator 112 may cause a change in pressure at the point 178 and hence in the sensed pressure chamber 162. For example, a decrease in system flow through the line 102 and the regulator 112 can cause a decrease in pressure at the point 178 and in the sensed pressure chamber 162. The higher pressure in the target pressure chamber 160 of the pilot 116 presses the diaphragm 164 towards the sensed pressure chamber 162, which therefore moves the valve member 158 to a more closed position. This restricts the flow of fluid from the outlet 142 of the inspirator 114 to the atmosphere, which in turn increases the pressure in the pressure control line 138 and in the pressure control chamber 136. As a result, the actuator diaphragm 128 advances towards the engagement surface 130 of the divider 132, thereby restricting flow through the flow channel 122 of the regulator 112 and increasing the pressure at the sensing point 178.

An increase in the sensed system pressure (at point 178, and in the sensed pressure chamber 162) may be caused by a increase in fluid flow through the regulator 112 (i.e. an increase in fluid consumption by the system). The higher pressure in the sensed pressure chamber 162 pushes the pilot diaphragm 164 towards the target pressure chamber 160, so that the valve member 158 is moved to a more open position. This increases the flow of fluid from the outlet 142 of the inspirator 114, which in turn reduces the pressure in the pressure control line 138 and the pressure control chamber 136 of the regulator 112. As a result, the diaphragm 128 retracts away from the engagement surface 130 of the divider 132, which increases flow through the channel 122 and decreases the pressure at the sensing point 178.

Accordingly, in response to a sensed pressure that is either higher or lower than the target pressure, the pressure control system 110 reacts to counteract the pressure deviation.

Further details of the fluid supply to the inlet 140 of the inspirator 114 will now be provided. A supply of actuator fluid through the inspirator supply line 146 can be provided by an independent (or auxiliary) fluid supply 188 that is passed through the secondary (higher pressure) pilot 118. The actuator fluid supply 188 can be a supply of any fluid that is isolated from the process fluid line 102, and is preferably supplied at a pressure greater than the target pressure input 170.

As best seen in FIG. 6, the secondary pilot 118 has a control portion 190 and a valve portion 192, which are fluidly isolated from each other. The valve portion 192 has an inlet port 194 and an outlet port 196, and a valve member 198 between the inlet port 194 and outlet port 196. An auxiliary supply line 199 connects the actuating fluid supply 188 to the inlet port 194 of the auxiliary pilot 118. The outlet port 196 is connected to the inspirator supply line 146.

The valve member 198 can move among a fully closed position, a fully open position, and a continuous range of partially open positions, so that the valve portion 192 of the secondary pilot 118 controls the flow of fluid from the actuating fluid supply 188 to the inlet 140 of the inspirator 114.

The control portion 190 of the secondary pilot 118 adjusts the position of the valve member 198 of the secondary pilot 118. The control portion 190 has a target pressure chamber 200 and a sensed pressure chamber 202 that are separated from each other by a secondary pilot diaphragm 204. The secondary pilot diaphragm 204 has a target pressure face 205a exposed to the target pressure chamber 200, and a sensed pressure face 205b exposed to the sensed pressure chamber 202. A pressure adjustment spring 203 is housed within the target pressure chamber 200 and exerts a force against the target pressure face 205a of the diaphragm 204, as does any fluid pressure in the target pressure chamber 200. The force of the spring 203 can be adjusted by turning an adjustment screw 207 to change the preload on the spring 203. By changing the relative pressures in the target and sensed pressure chambers 200, 202, the diaphragm 204 is moved towards the chamber 200 or 202 with the reduced pressure. The valve member 198 can be connected to the diaphragm 204 by, for example, a shaft 206, so that movement of the diaphragm 204 adjusts the position of the valve member 198. In the embodiment illustrated, the spring 203 is relatively stiff and the surface area of the faces 205a and 205b of the diaphragm 204 are relatively small (compared to those of the primary pilot 116).

The target pressure chamber 200 of the secondary pilot valve 118 can be in fluid communication with the control pressure input 170. More specifically, the control (or target) pressure input 170 can be in communication with the chamber 200 via a secondary pilot control line 210 connecting the control line 174 of the primary pilot 116 to a target port 212 of the chamber 200. A stabilizing needle valve 213 can be provided in the secondary pilot control line.

The outlet port 196 of the secondary pilot valve 118 is in fluid communication with the inspirator supply line 146. A sense line 214 extends from a sense port 216 of the sensed pressure chamber 202 to an orifice in the inspirator supply line 146 between the outlet port 196 of the valve portion 192 of the secondary pilot 118 and the inlet 140 of the inspirator 114.

In operation, the actuating fluid supply 188 can be supplied to the pressure control system 110, via the line 199, at a pressure that is greater than the target pressure (which is set as desired by the target pressure input 170). Without any additional force exerted on the diaphragm 204 by the spring 203, the fluid pressure to the outlet 196 of the secondary pilot 118 (and hence, the fluid pressure to the inlet 140 of the inspirator 114) is generally equal to the system target pressure. By adjusting the screw 207 to increase the force on the target face 205a of the diaphragm 204, fluid at a higher pressure can be passed to the inspirator 114. Accordingly, a greater pressure difference can be generated across the diaphragm 128 of the regulator 112.

Referring again to FIG. 1, in known pressure control systems using regulators 20, the regulator 20 is usually positioned so that the diaphragm 28 is facing vertically upwards, or in other words, the diaphragm 28 is generally horizontal having the chamber 26 above and the chamber 24 below. The divider 22 is oriented generally vertically, and a partial gap or flow channel is provided between the top of divider 22 and the bottom of diaphragm 28. The inventors have observed that when a process fluid stream comprises a saturated gas stream, a problem can occur if liquid is condensed in the chamber 24 of the pressure regulator 20. As the gas stream flows through the chamber 24, liquid can condense and accumulate in the upstream side (left side in FIG. 1) of the divider 22 causing partial blockage of the flow passage which can in turn create a significant pressure change in the gas stream. This can result in instability of pressure control and is therefore undesirable.

To overcome this problem, the pressure regulator 112 of the control system 110 can be rotated approximately 90 degrees around its axial direction, i.e. the direction of the process fluid stream therethrough (FIG. 7). As a result, during operation, the divider 132 is disposed generally in horizontal position, and the diaphragm 128 extends in a generally vertical direction, with the flow channel 122 on one side and the chamber 136 on the other side. In this configuration, condensed liquid can more easily flow through the flow channel 122 between the surfaces 126 and 130. This can eliminate any significant pressure change due to condensation, so that the pressure of the process gas stream can be controlled constantly at a steady level.

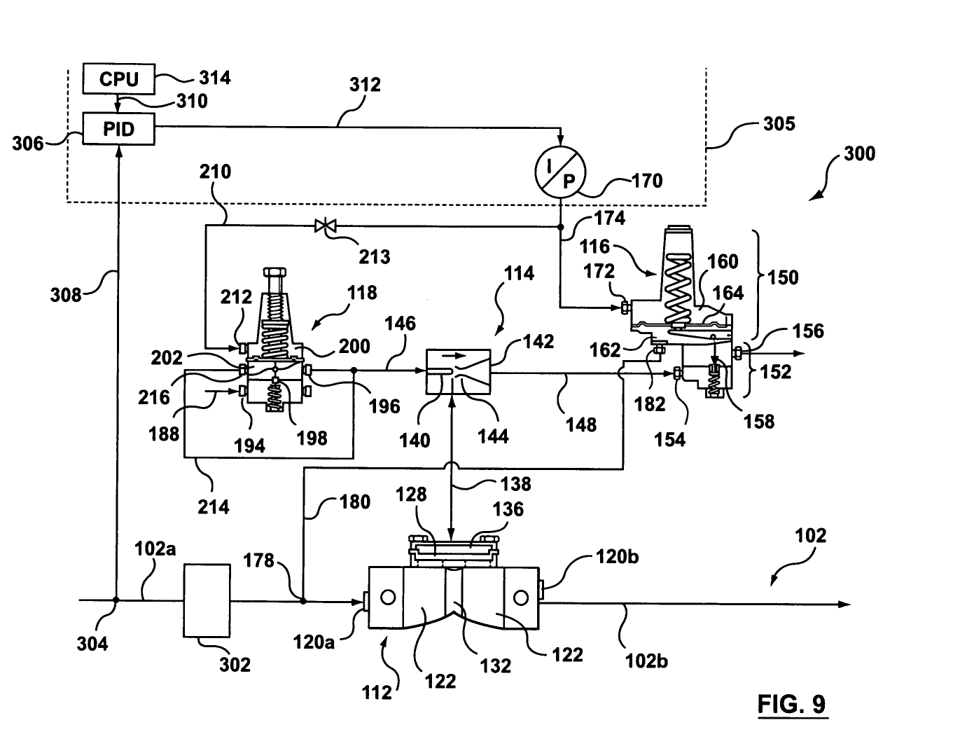

Another embodiment of the pressure control system according to the present invention is shown generally at 300 in FIG. 9. In this embodiment, process equipment 302 is provided in process fluid line 102 upstream of the sensing point 178 and upstream of the regulator 112. The process equipment 302 may include fuel cell stacks, electrolyzers, gas compression equipment, humidifiers, driers, water separators, heaters, coolers and mixers.

A pressure measurement means 304 is provided upstream of the process equipment 302. In the embodiment shown, pressure measurement means 304 is a pressure transducer for converting a pressure measured in the process fluid line 102 into an electrical signal. Such pressure transducers include, but are not limited to, strain gauges, piezoresistive transducers, and piezoelectric transducers.

Pressure measurement means 304 is connected to a control unit 305 (shown in phantom lines) including via a feedback line 308. In the embodiment shown, the control unit includes a controller 306, control module 314, and control input 170. The controller 306 is an electronic proportional-integral-derivative (PID) controller. The controller 306 is connected to a control module 314 via a set-point line 310, and to control input 170 via an adjusted set-point line 312. In the embodiment shown, the control module 314 includes a central-processing-unit (CPU) and is controllable by a user via a user interface (not shown).

In operation, the control module 314 provides a signal corresponding with a set-point to the controller 306, and the pressure measurement means 304 provides a signal corresponding with a measured pressure to the controller 306. The controller 306 compares the signals received from the control module 314 and the pressure measurement means 304 and, based on the comparison, provides a modified set-point to the control input 170 corresponding with a new target pressure that is communicated by the control input 170 to the target pressure chambers 160, 200 of the primary and secondary pilot valves 116, 118, respectively.

For example, when the controller 306 receives a signal from the pressure measurement means 304 corresponding with a measured pressure that is less than the set-point, the controller provides a modified set-point corresponding with an increased target pressure to the control input 170, and thereby the pressure control system 300 operates to increase the pressure of the fluid in the process fluid line 102. More particularly, the higher pressure communicated by the control input 170 to the target pressure chamber 160 of the pilot 116 presses the diaphragm 164 towards the sensed pressure chamber 162, which therefore moves the valve member 158 to a more closed position. This restricts the flow of fluid from the outlet 142 of the inspirator 114 to the atmosphere, which in turn increases the pressure in the pressure control line 138 and in the pressure control chamber 136. As a result, the actuator diaphragm 128 advances towards the engagement surface 130 of the divider 132, thereby restricting flow through the flow channel 122 of the regulator 112 and increasing the pressure in the process fluid line 102.

Likewise, when the controller 306 receives a signal from the pressure measurement means 304 corresponding with a measured pressure that is greater than the set-point, the controller will provide a modified set-point corresponding with a decreased target pressure to the control input 170, and thereby the pressure control system 300 will operate to decrease the pressure of the fluid in the process fluid line 102. More particularly, the lower pressure communicated by the control input 170 to the target pressure chamber 160 allows the pilot diaphragm 164 to move upwards, so that the valve member 158 is moved to a more open position. This increases the flow of fluid from the outlet 142 of the inspirator 114, which in turn reduces the pressure in the pressure control line 138 and the pressure control chamber 136 of the regulator 112. As a result, the diaphragm 128 retracts away from the engagement surface 130 of the divider 132, which increases flow through the channel 122 and decreases the pressure in the process fluid line 102.

As discussed, the electronic PID controller 306 compares the set-point received from the control module 314 with the measured pressure received from the pressure measurement means 304. Based on the comparison, the controller 306 provides a modified set-point to the control input 170 such that the pressure control system 300 will operate to adjust the pressure of the fluid in the process fluid line 102 to a value closer to the set-point. The modified set-point is calculated based on the combined outputs of the proportional, integral, and derivative control actions of the controller 306 in response to the difference between the set-point and the measured pressure; this difference is also referred to as the error. More particularly, the output of the proportional control action is based on a multiple of the error; the output of the integral control action is based on a multiple of the time integral of the error; and the output of the derivative control action is based on a multiple of the time derivative of the error. While the controller 306 may generate a modified set-point based on all three of the proportional, integral, and derivative control actions, it is also possible that only one or two of these control actions is used. The characteristics of the output of the control actions, as well as what combination of control actions are used, depend on the particular tuning of a given controller 306.

In one embodiment of the present invention, the pressure measured by the pressure measurement means 304, the set-point, and the modified set-point are represented by the current of the associated signals. For example, in a pressure control system in which the current of such signals ranges from 4 mA to 20 mA, which correspond with minimum and maximum process fluid line 102 pressures of 5 psi and 45 psi, respectively, a set-point of 25 psi would be represented by a current of 12 mA. Likewise, a measured pressure of 15 psi would be represented by a current of 8 mA. However, depending on the location of the measurement means 304 in the line 102 and other system characteristics, the modified set point could range from 4 to 20 mA.

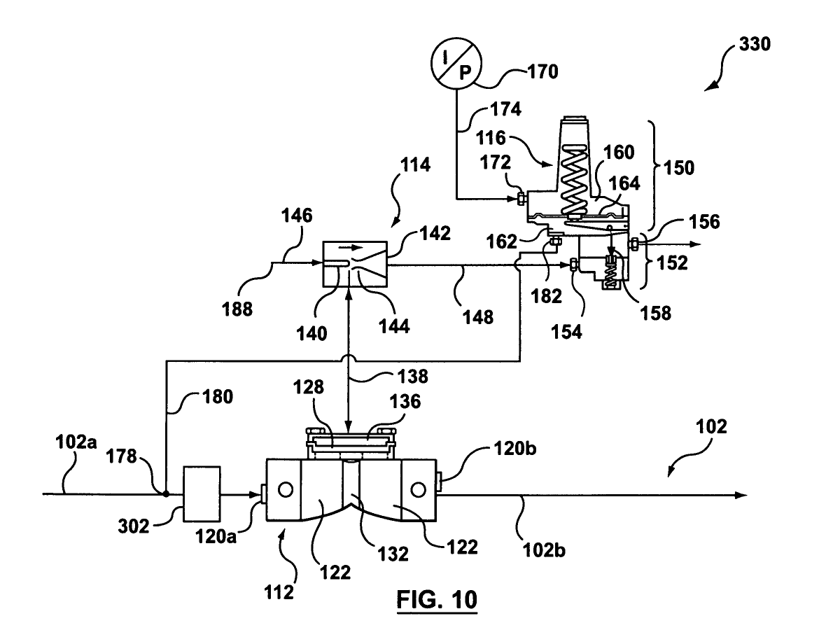

Another embodiment of the pressure control system according to the present invention is shown generally at 330 in FIG. 10. The embodiment shown is similar to that shown in FIG. 2, however, in this embodiment the inspirator supply line 146 is connected to the actuating fluid supply 188, and the secondary pilot valve 118 is removed. Process equipment 302 is provided intermediate the sense point 178 and the regulator 112 in the process fluid supply line 102.

In operation, as similarly described above in relation to the embodiment shown in FIG. 2, a pressure drop in the sensed system pressure (i.e. in pressure chamber 162) may be caused by a decrease in fluid flow through the regulator 112 (i.e. a decrease in fluid consumption by the system). The higher pressure in the target pressure chamber 160 of the pilot 116 presses the diaphragm 164 towards the sensed pressure chamber 162, which therefore moves the valve member 158 to a more closed position. This restricts the flow of fluid from the outlet 142 of the inspirator 114 to the atmosphere, which in turn increases the pressure in the pressure control line 138 and in the pressure control chamber 136. As a result, the actuator diaphragm 128 advances towards the engagement surface 130 of the divider 132, thereby restricting flow through the flow channel 122 of the regulator 112 and increasing the pressure at the sensing point 178.

An increase in the sensed system pressure (at point 178, and in the sensed pressure chamber 162) may be caused by a decrease in fluid flow through the regulator 112 (i.e. a decrease in fluid consumption by the system). The higher pressure in the sensed pressure chamber 162 pushes the pilot diaphragm 164 towards the target pressure chamber 160, so that the valve member 158 is moved to a more open position. This increases the flow of fluid from the outlet 142 of the inspirator 114, which in turn reduces the pressure in the pressure control line 138 and the pressure control chamber 136 of the regulator 112. As a result, the diaphragm 128 retracts away from the engagement surface 130 of the divider 132, which increases flow through the channel 122 and decreases the pressure at the sensing point 178.

Similarly, in another embodiment (not shown) also having the secondary pilot valve 118 removed, the primary pilot valve 116 is located upstream of the inspirator 114. Accordingly, the actuating fluid supply 188 is connected to inlet port 154 and the outlet port 156 is connected to the inspirator supply line 146. The operation of this embodiment is similar to that described above in relation to FIG. 10.

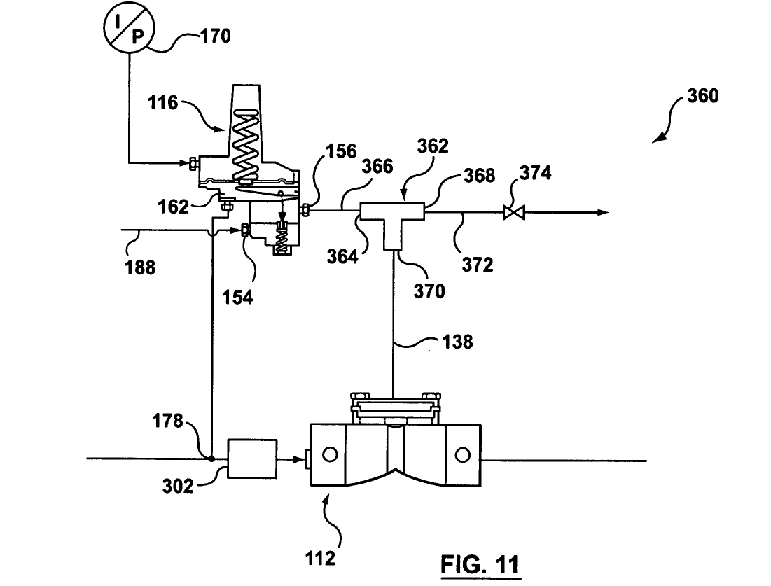

Another embodiment of the pressure control system according to the present invention is shown generally at 360 in FIG. 11. This embodiment is similar to that shown in FIG. 2, however, in the embodiment shown, the primary pilot valve 116 is removed and the secondary pilot valve 118 is located upstream of a T-junction 362. Accordingly, the actuating fluid supply 188 is connected to the inlet port 194 and the outlet port 196 is connected to a T-junction inlet 364 via a T-junction supply line 366. A T-junction outlet 368 is connected to a stabilizing needle valve 374 via a T-junction vent line 372. Process equipment 302 is provided intermediate the sense point 178 and the regulator 112 in the process fluid supply line 102.

The T-junction 362 receives a flow of actuator fluid at its inlet 364, and discharges a flow of actuator fluid from its outlet 368. The T-junction has a stem 370 in fluid communication with its inlet 364 and outlet 368 and connected to the pressure control line 138. In operation, the pressure of the actuator fluid flowing from the inlet 364 to the outlet 368 is communicated to the actuator fluid in the stem 370, the control line 138 and, accordingly, the control chamber 136 of the regulator 112. The stabilizing needle valve 374 serves to generate back-pressure in the upstream actuator fluid.

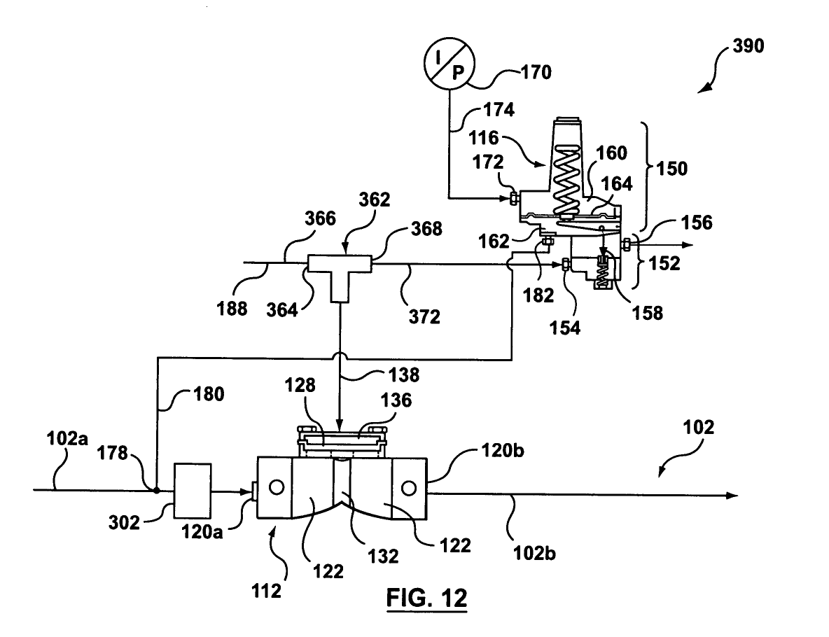

Another embodiment of the pressure control system according to the present invention is shown generally at 390 in FIG. 12. The embodiment shown is similar to that shown in FIG. 10, however, in this embodiment the inspirator 114 is replaced with the T-junction 362. Accordingly, the actuating fluid supply 188 is connected to the T-junction inlet 364 via the T-junction supply line 366. The T-junction outlet 368 is connected to inlet port 154 via the T-junction vent line 372. The operation of this embodiment is similar to that described above in relation to FIG. 10.

In one application of the pressure control system 110, a fuel cell stack was placed between the pressure control point 178 in the line 102a and the inlet 120a of the pressure regulator. Test results of this example are provided hereinafter. It is to be appreciated, however, that the present system 110 can be used to control pressure of the process fluid stream at any arbitrary location along the process fluid stream line.

It is also to be appreciated that, while in the embodiments of the invention described particular orders in which the sensing point 178, pressure measurement means 304, process equipment 302, and regulator 112 are provided in the process fluid stream 102 are specified, the invention is not be limited by any particular order and that orders other than those specifically described are within the scope of the present invention. For example, the invention has been described in relation to a configuration where the pressure is sensed upstream from the pressure regulator 112. In particular, the invention is intended for particular application with fluid cell stacks where the fuel cell stacks are interposed between the sensing port 178 and the pressure regulator 112, or between the sensing port 178 and the pressure measurement means 304, depending on the embodiment. However, the invention also has applicability where it is desired to control the pressure downstream from the pressure regulator 112. In this case, the operation of the first pilot valve 116 will need to be reversed. Thus, if the downstream pressure was sensed to be too high then it would be necessary to reduce the flow of fluid through the pressure regulator 112 to the downstream location. In response to excess sensed pressure, the valve member 158 would need to moved to a more closed position thereby to reduce the flow from the inspirator 114, in turn increasing the pressure of the actuating fluid delivered through the line 138 to the pressure regulator 112, so as to tend to close the pressure regulator 112 and reduce flow of fluid through it. Correspondingly, if the downstream pressure is sensed to be too low, then the pilot valve 116 needs to be opened so as to permit greater flow of fluid through it from the inlet port 154 to the outlet port 156. This greater flow of actuating fluid would reduce the pressure at the throat of the inspirator 114, in turn reducing the pressure applied to the pressure regulator 112, so as to let greater flow of fluid through the pressurized regulator 112, so as in turn to increase the downstream pressure.

It is also to be appreciated that the present invention can be applied in many industrial applications, where accurate control of the pressure of a process fluid stream is desirable, especially under low pressure and/or high flow conditions, including but not limited to a fuel cell system.

### EXAMPLE

In a test run, the control pressure at inlet 170 was set at about 20 psi. The auxiliary supply stream was provided at about 100 psi. The adjustment screw 207 was adjusted so that the total force exerted on the target pressure face 205a of the diaphragm 204 was equivalent to about 25 psi. A fluid consuming device in the form of a load cell stack was disposed in the upstream fluid line 102a, between the control point and the regulator 112.

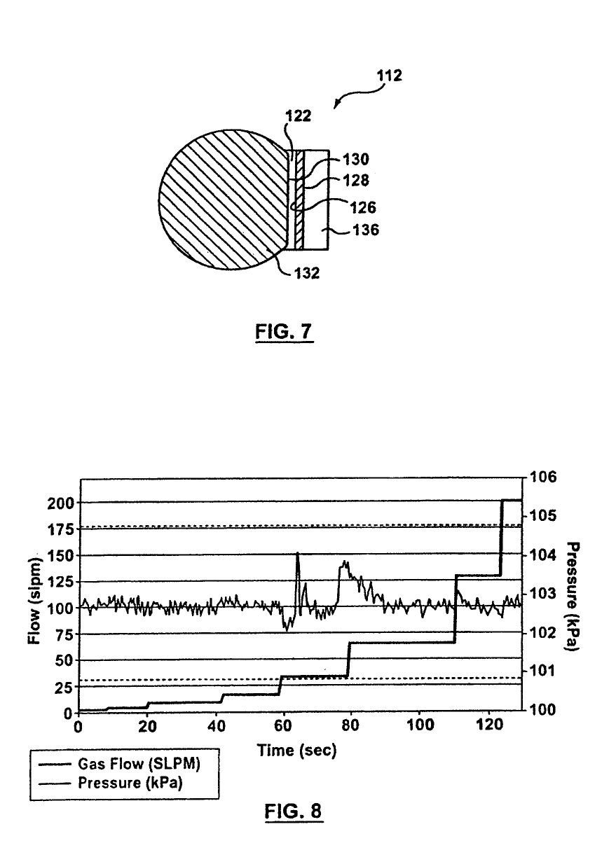

FIG. 8 shows test results when the present pressure control system in employed in a fuel cell system. As can be seen, although the process gas flow changes dramatically from near zero slpm to 200 slpm, the pressure of the process fluid at a certain point in the system is maintained at reasonably constant level.

While the above description constitutes the preferred embodiments, it will be appreciated that the present invention is susceptible to modification and change without departing from the fair meaning of the proper scope of the accompanying claims.

1. A pressure control system for controlling the pressure of a process fluid stream at a certain location in response to a pressure disturbance caused by process equipment located in the process fluid stream, the pressure control system comprising:
f. a pressure regulator having an inlet and an outlet for the process fluid and including an actuating element actuated by pressure of an actuating fluid to control opening of the pressure regulator and thereby to control flow of the process fluid between the inlet and outlet thereof;
g. a fluid control means having an inlet and an outlet and a control line intermediate the inlet and the outlet, wherein the inlet is connected to a supply of actuating fluid, the control line is connected to the pressure regulator to control supply of the actuating fluid to the pressure regulator and thereby to control the pressure regulator, and the outlet provides an exit for the actuating fluid;
h. a first pilot valve, including a first sense port for receiving a sensed fluid pressure from a first location in the process fluid stream, a first target port for inputting a target pressure, an inlet port for receiving actuating fluid connected to the outlet of the fluid control means, an outlet port, and a first valve actuable in response to the sensed fluid pressure to control flow of the actuating fluid from the fluid control means and thereby to control flow of the actuating fluid to the pressure regulator;
i. a pressure measurement means for measuring fluid pressure at a second location in the process fluid stream and outputting a signal corresponding with the pressure measurement;
j. a control unit for receiving the signal from the pressure measurement means, comparing the signal with a set-point, and
communicating the target pressure to the first target port, wherein the first and second locations for measuring pressure are located on either side of the process equipment.

2. A pressure control system as claimed in claim 1, wherein the fluid control means comprises an inspirator having an inlet, an outlet and throat between the inlet and the outlet thereof, and wherein the pressure regulator includes a control chamber partially defined by the actuating element and connected to the throat of the inspirator, and the outlet of the inspirator is connected to the inlet port of the first pilot valve, whereby, in use, the first valve controls the flow of actuating fluid through the inspirator, with opening of the first valve tending to increase the flow through the inspirator and correspondingly to decrease the pressure in the control chamber, and closing of the first valve tending to decrease the flow through the inspirator and correspondingly to increase the pressure in the control chamber.

3. A pressure control system as claimed in claim 1, wherein the fluid control means comprises a T-junction having a T-junction inlet, a T-junction outlet, and a stem portion located intermediate the T-junction inlet and the T-junction outlet, wherein the T-junction outlet is connected to the inlet port of the first pilot valve, wherein the pressure regulator includes a control chamber partially defined by the actuating element and connected to the stem portion, and wherein the T-junction inlet, the T-junction outlet and control chamber are in fluid communication, whereby, in use, the first valve controls the flow of actuating fluid through the T-junction, with opening of the first valve tending to increase the flow through the T-junction and correspondingly to increase the pressure in the control chamber, and closing of the first valve tending to decrease the flow through the T-junction and correspondingly to decrease the pressure in the control chamber.

4. A pressure control system as claimed in claim 1, wherein the first pilot valve includes a target pressure chamber and a sensed pressure chamber, the target pressure chamber including the first target port and the sensed pressure chamber including the first sense port, and the first pilot valve includes a first diaphragm means subject to the pressures of the target pressure and sensed pressure chambers and connected to the first valve for actuation thereof.

5. A pressure control system as claimed in claim 4, wherein the outlet port of the first pilot valve is open to atmosphere, whereby when the first valve is open, the inlet port for the actuating fluid is vented to atmosphere.

6. A pressure control system as claimed in claim 4, wherein the first pilot valve includes means for adjusting the pressure differential between the pressures in the sensed and target pressure chambers necessary to open the first valve of the first pilot valve.

7. A pressure control system as claimed in claim 4, wherein the first valve of the first pilot valve includes a shaft, and wherein the pilot valve includes a lever pivotably connected to said shaft, to a housing of the first pilot valve and to the first diaphragm means, for actuation of the first valve.

8. A pressure control system as claimed in claim 1, further comprising a second pilot valve, including an inlet port connected to the supply of actuating fluid, a second target port for receiving the target pressure from the control unit, an outlet port for the actuating fluid connected to the inlet of the fluid control means, and a second valve actuable to deliver the actuating fluid at a desired actuating fluid pressure to the fluid control means, wherein the control unit is connected to the second target port for communicating the target pressure.

9. A pressure control system as claimed in claim 8, wherein the second pilot valve includes a second target pressure chamber connected to the second target port and a second sensed pressure chamber having a second sense port, wherein the outlet port for the actuating fluid is connected to the second sense port, and wherein a second diaphragm is provided between the second target and second sensed pressure chambers and is connected to the second valve to control actuation thereof.

10. A pressure control system as claimed in claim 9, wherein the second pilot valve includes means for varying a target pressure differential between the second target and second sensed pressure chambers necessary to displace the second diaphragm and thereby displace the second valve, to control flow of the actuating fluid from the inlet port for the actuating fluid to the outlet port for the actuating fluid in the second pilot valve.

11. A pressure control system as claimed in claims 8, 9 or 10 including a stabilizing needle valve provided between the control unit and the second target port.

12. A pressure control system as claimed in claim 1, wherein the pressure regulator comprises a flexible actuating diaphragm incorporating the actuating element and a sealing surface, whereby sufficient pressure of the actuating fluid presses the pressure regulator diaphragm against the sealing surface to close the pressure regulator.

13. A pressure control system as claimed in claim 12, wherein the pressure regulator is mounted with the diaphragm and the sealing surface extending substantially vertically.

14. A pressure control system as claimed in claim 1, wherein the pressure measurement means comprises a pressure transducer for sending an electrical signal to the control unit, indicative of the pressure measured by the pressure transducer in the process fluid stream.

15. A pressure control system as claimed in claim 1, wherein the control unit includes a controller for receiving a set-point from a control module and for outputting an adjusted set-point signal corresponding with the target pressure, and a control input for receiving the adjusted set-point signal from the controller and communicating the target pressure to the first target port.

16. A pressure control system as claimed in claim 15, wherein the controller is an electronic proportional-integral-derivative controller.

17. A pressure control system as claimed in claim 15, wherein the control input is an electronic pressure regulator for regulating the pressure in the first target pressure chamber, and wherein the control input comprises means for controlling the flow of pressurized fluid communicated to the first target pressure chamber in response to the adjusted set-point signal.

18. A pressure control system as claimed in claim 15, wherein the control module comprises a central processing unit.

19. A pressure control system as claimed in claim 1, in combination with process equipment selected from the group consisting of a fuel cell stack, an electrolyzer, and a compressor.

20. A pressure control system as claimed in claim 19, wherein the first location in the process fluid stream is downstream from the process equipment and the second location in the process fluid stream is upstream from the process equipment.

21. A pressure control system as claimed in claim 20, wherein at least one of the first and second locations is upstream from the pressure regulator.

22. A pressure control system for controlling the pressure of a process fluid stream at a certain location in response to a pressure disturbance caused by process equipment located in the process fluid stream, the pressure control system comprising:
a. a pressure regulator having an inlet and an outlet for the process fluid and including an actuating element actuated by pressure of an actuating fluid to control opening of the pressure regulator and thereby to control flow of the process fluid between the inlet and outlet thereof;
b. a fluid control means having an inlet and an outlet and a control line intermediate the inlet and the outlet, wherein the inlet is connected to a supply of actuating fluid, the control line is connected to the pressure regulator to control supply of the actuating fluid to the pressure regulator and thereby to control the pressure regulator, and the outlet providing an exit for the actuating fluid;
c. a first pilot valve, including a first sense port for receiving a sensed fluid pressure from a first location in the process fluid stream, a first target port for inputting a target pressure, an inlet port for receiving actuating fluid connected to the outlet of the fluid control means, an outlet port, and a first valve actuable in response to the sensed fluid pressure to control flow of the actuating fluid from the fluid control means and thereby to control flow of the actuating fluid to the pressure regulator; and
d. a second pilot valve, including an inlet port connected to the supply of actuating fluid, a second target port for receiving the target pressure, an outlet port for the actuating fluid connected to the inlet of the fluid control means, and a second valve actuable to deliver the actuating fluid at a desired actuating fluid pressure to the fluid control means

23. A pressure control system as claimed in claim 22, wherein the fluid control means comprises an inspirator having an inlet, an outlet and throat between the inlet and the outlet thereof, and wherein the pressure regulator includes a control chamber partially defined by the actuating element and connected to the throat of the inspirator, and the outlet of the inspirator is connected to the inlet port of the first pilot valve, whereby, in use, the first valve controls the flow of actuating fluid through the inspirator, with opening of the first valve tending to increase the flow through the inspirator and correspondingly to decrease the pressure in the control chamber, and closing of the first valve tending to decrease the flow through the inspirator and correspondingly to increase the pressure in the control chamber.

24. A pressure control system as claimed in claim 22, wherein the fluid control means comprises a T-junction having a T-junction inlet, a T-junction outlet, and a stem portion located intermediate the T-junction inlet and the T-junction outlet, wherein the T-junction outlet is connected to the inlet port of the first pilot valve, wherein the pressure regulator includes a control chamber partially defined by the actuating element and connected to the stem portion, and wherein the T-junction inlet, the T-junction outlet and control chamber are in fluid communication, whereby, in use, the first valve controls the flow of actuating fluid through the T-junction, with opening of the first valve tending to increase the flow through the T-junction and correspondingly to increase the pressure in the control chamber, and closing of the first valve tending to decrease the flow through the T-junction and correspondingly to decrease the pressure in the control chamber.

25. A pressure control system as claimed in claim 22, 23 or 24, in combination with process equipment selected from the group consisting of a fuel cell stack, an electrolyzer, and a compressor.

26. A pressure control system for controlling the pressure of a process fluid stream at a certain location in response to a pressure disturbance caused by process equipment located in the process fluid stream, the pressure control system comprising:
a. a pressure regulator having an inlet and an outlet for the process fluid and including an actuating element actuated by pressure of an actuating fluid to control opening of the pressure regulator and thereby to control flow of the process fluid between the inlet and outlet thereof;
b. a fluid control means having an inlet and an outlet and a control line intermediate the inlet and the outlet, wherein the inlet is connected to a supply of actuating fluid, the control line is connected to the pressure regulator to control supply of the actuating fluid to the pressure regulator and thereby to control the pressure regulator, and the outlet provides an exit for the actuating fluid;
c. a first pilot valve, including a first sense port for receiving a sensed fluid pressure from a first location in the process fluid stream, a first target port for inputting a target pressure, an inlet port for receiving actuating fluid, an outlet port connected to the inlet of the fluid control means, and a first valve actuable in response to the sensed fluid pressure to control flow of the actuating fluid to the fluid control means and thereby to control flow of the actuating fluid to the pressure regulator; and
means for restricting the flow of actuator fluid having an inlet connected to the outlet of the fluid control means, and an outlet.

27. A pressure control system as claimed in claim 26, including:
a. pressure measurement means for measuring fluid pressure at a second location in the process fluid stream and outputting a signal corresponding with the pressure measurement; and
b. control unit for receiving the signal from the pressure measurement means, comparing the signal with a set-point, and communicating the target pressure to the first target port.

28. A pressure control system as claimed in claim 27, wherein the fluid control means comprises an inspirator having an inlet, an outlet and throat between the inlet and the outlet thereof, and wherein the pressure regulator includes a control chamber partially defined by the actuating element and connected to the throat of the inspirator, and the outlet of the inspirator is connected to the inlet port of the first pilot valve, whereby, in use, the first valve controls the flow of actuating fluid through the inspirator, with opening of the first valve tending to increase the flow through the inspirator and correspondingly to decrease the pressure in the control chamber, and closing of the first valve tending to decrease the flow through the inspirator and correspondingly to increase the pressure in the control chamber.

29. A pressure control system as claimed in claim 28, wherein the means for restricting the flow of actuator fluid is a stabilizing needle valve.

30. A pressure control system as claimed in claim 27, wherein the pressure regulator comprises a flexible actuating diaphragm incorporating the actuating element and a sealing surface, whereby sufficient pressure of the actuating fluid presses the pressure regulator diaphragm against the sealing surface to close the pressure regulator.

31. A pressure control system as claimed in claim 30, wherein the pressure regulator is mounted with the diaphragm and the sealing surface extending substantially vertically.

32. A pressure control system as claimed in claim 27, including a control input for receiving a set-point and communicating the corresponding target pressure to the first target port.

33. A pressure control system for controlling the pressure of a process fluid stream at a certain location in response to a pressure disturbance caused by process equipment located in the process fluid stream, the pressure control system comprising:
a. a pressure regulator having an inlet and an outlet for the process fluid and including an actuating element actuated by pressure of an actuating fluid to control opening of the pressure regulator and thereby to control flow of the process fluid between the inlet and outlet thereof;
b. a fluid control means having an inlet and an outlet and a control line intermediate the inlet and the outlet, wherein the inlet is connected to a supply of actuating fluid, the control line is connected to the pressure regulator to control supply of the actuating fluid to the pressure regulator and thereby to control the pressure regulator, and the outlet provides an exit for the actuating fluid;
c. process equipment connect to the inlet of the pressure regulator, and upstream of the pressure regulator
d. a first pilot valve, including a first sense port for receiving a sensed fluid pressure from a first location in the process fluid stream upstream of the process equipment, a first target port for inputting a target pressure, and an inlet port and an outlet port, the first pilot valve being connected by one of said inlet and outlet ports thereof to the fluid control means with the other of the inlet and the outlet ports thereof being connected to a line for actuating fluid, and a first valve actuable in response to the sensed fluid pressure to control flow of the actuating fluid through the fluid control means and thereby to control flow of the actuating fluid to the pressure regulator.
